(19) United States
(12) Patent Application Publication
(10) Pub. No.: US 2018/0302613 A1
(43) Pub. Date: Oct. 18, 2018

(54) METHOD AND APPARATUS FOR CONTROLLING NAKED EYE STEREOSCOPIC DISPLAY AND DISPLAY DEVICE

(71) Applicants: HKC CORPORATION LIMITED, GUANGDON (CN); CHONGQING HKC OPTOELECTRONICS TECHNOLOGY CO., LTD., CHONGQING (CN)

(72) Inventor: Yu-jen CHEN, Taiwan (CN)

(73) Assignees: HKC CORPORATION LIMITED, GUANGDON (CN); CHONGQING HKC OPTOELECTRONICS TECHNOLOGY CO. LTD., CHONGQING (CN)

(21) Appl. No.: 15/568,707

(22) PCT Filed: Feb. 27, 2017
(86) PCT No.: PCT/CN2017/075049

§ 371 Date: Oct. 23, 2017

(30) Foreign Application Priority Data
Nov. 22, 2016 (CN) 201611046121.5

(51) Int. Cl. H04N 13/398; H04N 13/15; H04N 17/04; H04N 13/383; H04N 13/305

(52) U.S. Cl. CPC H04N 13/398; H04N 13/15; G09G 3/3607; H04N 13/383; H04N 13/305; H04N 17/04

(57) ABSTRACT

A method and an apparatus for controlling naked eye stereoscopic display and a display device are provided. The method includes detecting a stereoscopic display instruction of a display device, where the display device is divided into a plurality of view point regions, each of the plurality of view point regions includes at least two view points; and adjusting a greyscale value of a sub-pixel corresponding to one of adjacent view points belonging respectively to adjacent ones of the plurality of view point regions to a preset greyscale value when the stereoscopic display instruction of the display device is detected so that a user can observe a plane image in a reverse-scopic region.

### TECHNICAL FIELD

The present disclosure relates to the field of display technology, particularly to a method and an apparatus for controlling naked eye stereoscopic display and a display device.

### BACKGROUND

A naked eye stereoscopic display device is of great concern for its stereoscopic visual effect for naked eyes without auxiliary glasses. Two well-developed naked eye stereoscopic display modes are slit mode and lens mode. The lens mode is widely used since light is split through refraction without reducing light intensity and thus has a good stereoscopic visual effect and it can also display a plane image and is environment-friendly and energy-saving.

During a stereoscopic display process on a multi-view-point display device, when adjacent view points located in adjacent view point regions are paired, a reverse-scopic region occurs in a user's observation region. An image the user observes in the reverse-scopic region is left-and-right reversed (reverse-scopic), easily causing visual fatigue or even untoward effects such as dizziness.

### SUMMARY

The present disclosure provides a method and an apparatus for controlling naked eye stereoscopic display and a display device. The method and the apparatus for controlling naked eye stereoscopic display and the display device can eliminate reverse-scopic phenomena and thus alleviate visual fatigue and avoid untoward effects such as dizziness.

According to the first aspect, an embodiment of the present disclosure provides a method for controlling naked eye stereoscopic display including at least one processor and a memory.

The memory stores computer-executable instructions executable by the at least one processor. The at least one processor performs operations in the following modules when the computer-executable instructions are executed by the at least one processor:

detecting a stereoscopic display instruction of a display device. The display device is divided into a plurality of view point regions, each of the plurality of view point regions includes at least two view points; and

adjusting a greyscale value of a sub-pixel corresponding to one of adjacent view points to a preset greyscale value when the stereoscopic display instruction of the display device is detected, so that a user can observe a plane image in a reverse-scopic region, wherein the adjacent view points respectively belongs to adjacent ones of the plurality of view point regions.

According to the second aspect, an embodiment of the present disclosure provides an apparatus for controlling naked eye stereoscopic display including:

a stereoscopic display instruction detection module. The stereoscopic display instruction detection module is configured to detect a stereoscopic display instruction of a display device. The display device is divided into a plurality of view point regions, and each of the plurality of view point regions includes at least two view points; and

a greyscale value adjusting module. The greyscale value adjusting module is configured to adjust a greyscale value of a sub-pixel corresponding to one of adjacent view points to a preset greyscale value when the stereoscopic display instruction of the display device is detected, so that a user can observe a plane image in a reverse-scopic region, wherein the adjacent view points respectively belongs to adjacent ones of the plurality of view point regions.

According to the third aspect, an embodiment of the present disclosure provides a display device including a display panel and a lens layer disposed on a light outgoing side of the display panel.

the display panel includes a plurality of sub-pixels disposed in a matrix form in a display region and a control circuit disposed in a non-display region;

the control circuit includes an apparatus for controlling naked eye stereoscopic display as described in the second aspect; and

the lens layer is used to project a display picture of each of the plurality of sub-pixels in different directions so that a user can observe a stereoscopic image in an orthoscopic region.

According to the fourth aspect, a method for controlling naked eye stereoscopic display includes:

detecting a stereoscopic display instruction of a display device, wherein the display device is divided into a plurality of view point regions, each of the plurality of view point regions includes at least two view points, each view point region includes four view points corresponding to a white sub-pixel, a red sub-pixel, a green sub-pixel and a blue sub-pixel, respectively; and

adjusting a greyscale value of the white sub-pixel corresponding to one of adjacent view points belonging respectively to adjacent ones of the plurality of view point regions to 0 according to a preset correspondence between a greyscale voltage and a greyscale value of each sub-pixel when the stereoscopic display instruction of the display device is detected so that a user can observe a plane image in a reverse-scopic region, where the greyscale value of each sub-pixel ranges from 0 to 255.

According to the fifth aspect, an embodiment of the present disclosure provides a non-transient computer-readable memory that stores computer-executable instructions configured to execute the method for controlling naked eye stereoscopic display.

According to the sixth aspect, an embodiment of the present disclosure provides a display device including:

at least one processor; and

a memory communicatively connected to the at least one processor, where

the memory stores instructions executable by the at least one processor, the at least one processor executes the instructions to execute the method for controlling naked eye stereoscopic display.

The present disclosure provides a method and an apparatus for controlling naked eye stereoscopic display and a display device. During stereoscopic display on the display device, adjusting the greyscale value of the sub-pixel corresponding to one of adjacent view points belonging respectively to adjacent ones of the plurality of view point regions to a preset greyscale value enables a user to observe a plane image in a reverse-scopic region. The reverse-scopic phenomenon is eliminated and thus the visual fatigue is slowed and untoward effects such as dizziness are avoided.

### BRIEF DESCRIPTION OF DRAWINGS

Exemplary embodiments of the present disclosure will now be described in detail with reference to the accompanying drawings to make the above and other features of the present disclosure apparent to those skilled in the art.

FIG. 1 is a planar structural diagram of a lens-mode naked eye stereoscopic display device in the related art.

FIG. 2 is a schematic diagram of naked eye stereoscopic display according to an embodiment of the present disclosure.

FIG. 3 is a flowchart of a method for controlling naked eye stereoscopic display according to an embodiment of the present disclosure.

FIG. 4 is a block diagram of an apparatus for controlling naked eye stereoscopic display according to an embodiment of the present disclosure.

FIG. 5 is a sectional diagram of a display device according to an embodiment of the present disclosure.

FIG. 6 is a hardware structural diagram of a display device according to an embodiment of the present disclosure.

### DETAILED DESCRIPTION

The technical solution of the present disclosure is described more fully hereinafter through specific embodiments in connection with the accompanying drawings. The detailed description of the embodiments set forth below is intended to explain and not to limit the present disclosure. It is to be noted that to facilitate description, only a part related to the present disclosure rather than the whole structure is illustrated in the drawings. If not in collision, the following embodiments and the features thereof may be combined with each other.

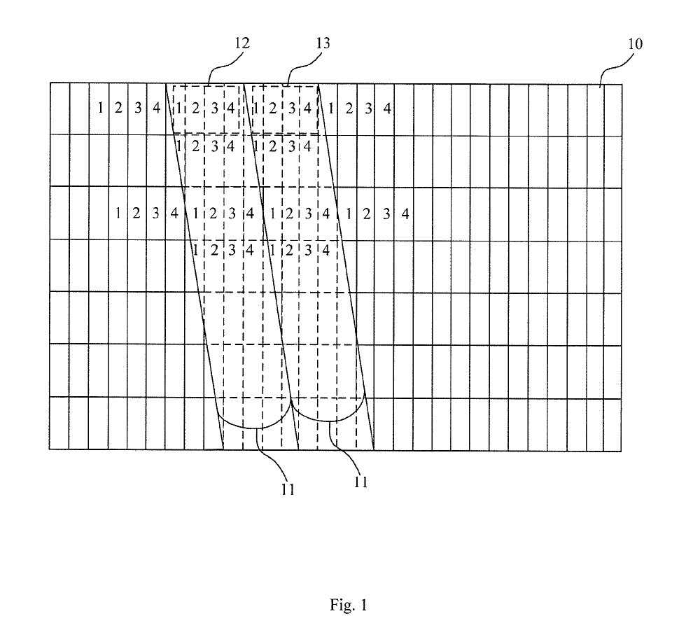

FIG. 1 is a planar structural diagram of a lens-mode naked eye stereoscopic display device in the related art. As shown in FIG. 1, the display device may include a display panel 10 and a cylindrical lens array (including a plurality of cylindrical lenses 11) disposed obliquely on a light outgoing side of the display panel 10. The display panel may be divided into a plurality of view point regions (for example, a first view point region 11 and a second view point region 13) disposed in a matrix form. Each of the plurality of view point regions includes at least two view points. As shown in FIG. 1, each of the plurality of view point regions may include a first view point 1, a second view point 2, a third view point 3 and a fourth view point 4. Each of the plurality of cylindrical lenses 11 covers one of the view point regions in each row (a horizontal direction in FIG. 1). A display picture of each sub-pixel on the display panel 10 may be projected in different directions using the cylindrical lens 11.

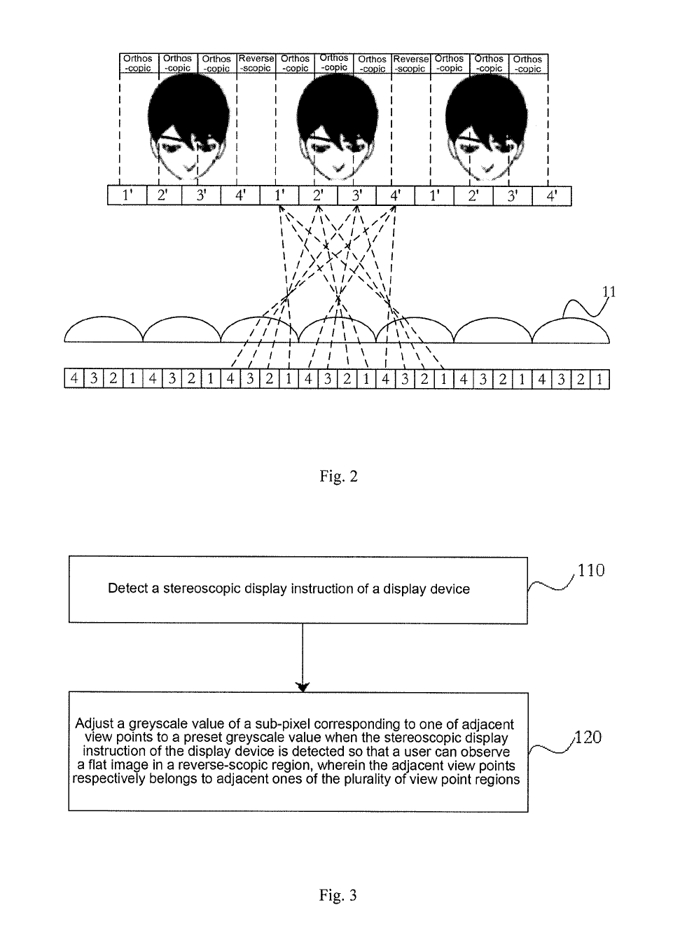

As shown in FIG. 1 and FIG. 2, during stereoscopic display of the display device, each of the display pictures of the first view point 1, the second view point 2, the third view point 3 and the fourth view point 4 may be displayed alternately according to each corresponding sub-pixel. The first view point 1 and the second view point 2 are paired to form an orthoscopic region (1′, 2′). The second view point 2 and the third view point 3 are paired to form an orthoscopic region (2′, 3′). The third view point 3 and the fourth view point 4 are paired to form an orthoscopic region (3′, 4′). The fourth view point 4 and the first view point 1 are paired but form a reverse-scopic region (4′, 1′) due to reversed stereoscopic information. The scopic region 1′ is formed by the first view point 1 projected through the cylindrical lens 11. The scopic region 2′ is formed by the first view point 2 projected through the cylindrical lens 11. The scopic region 3′ is formed by the first view point 3 projected through the cylindrical lens 11. The scopic region 4′ is formed by the first view point 4 projected through the cylindrical lens 11. An image a user observes in the reverse-scopic region is left-and-right reversed (reverse-scopic), easily causing visual fatigue or even untoward effects such as dizziness.

FIG. 3 is a flowchart of a method for controlling naked eye stereoscopic display according to an embodiment of the present disclosure. The method can eliminate reverse-scopic phenomena on a lens-mode naked eye stereoscopic display device and may be executed by a naked eye stereoscopic display apparatus. The apparatus may operate through software, hardware or a combination of the two.

In step 110, a stereoscopic display instruction of the display device is detected.

In this step, as shown in FIG. 1, the display device is divided into a plurality of view point regions, and each of the plurality of view point regions includes at least two view points. Each view point may correspond to a different sub pixel. The sub pixels corresponding to the view points may be a white sub-pixel, a red sub-pixel, a green sub-pixel and a blue sub-pixel, respectively. According to the exemplary embodiment, flat display and stereoscopic display can be switched to each other on the display device. When a user presses a key for switching to flat display or stereoscopic display, a flat display instruction or stereoscopic display instruction of the display device is detected and then an operation for controlling display is performed according to the flat display instruction or stereoscopic display instruction.

In step 120, a greyscale value of the sub-pixel corresponding to one of adjacent view points belonging respectively to adjacent ones of the plurality of view point regions is adjusted to a preset greyscale value when the stereoscopic display instruction of the display device is detected so that a user can observe a plane image in a reverse-scopic region.

According to the embodiment, each of the plurality of view point regions includes four view points corresponding to a white sub-pixel, a red sub-pixel, a green sub-pixel and a blue sub-pixel, respectively. Any two sub-pixels may correspond to adjacent view points belonging respectively to adjacent ones of the plurality of view point regions.

Optionally, sub-pixels corresponding to the adjacent view points belonging respectively to adjacent ones of the plurality of view point regions include the white sub-pixel. When the greyscale value of the white sub-pixel is adjusted to the preset greyscale value, display color loss can be reduced or avoided.

According to the embodiment, the white sub-pixel included in sub-pixels corresponding to the adjacent view points belonging respectively to adjacent ones of the plurality of view point regions is adjusted to a black greyscale, so that a user in the reverse-scopic cannot see an image displayed by the white sub-pixel and thus can see a plane image, thereby avoiding reverse-scopic phenomena.

Exemplarily, the greyscale of the white sub-pixel can be adjusted to the black greyscale by the operation of adjusting its greyscale value. Using 256 greyscales as an example, a greyscale value of each sub-pixel ranges from 0 to 255. To avoid impact by the image displayed by the white sub-pixel, the preset greyscale value may be not greater than 10.

Optionally, when the display device is a Liquid Crystal Display (LCD) device, the drive voltage of the Thin Film Transistor (TFT) of the white sub-pixel can be adjusted to change the electric filed between the white pixel electrode and the common electrode, thereby causing liquid crystal molecule deflection, reducing transmittance of backlight at the white sub-pixel and thus enabling the greyscale value of the white sub-pixel to reach the preset greyscale value. For example, when the drive voltage is 0, the greyscale value of the white sub-pixel is also 0. In this case, the white sub-pixel is totally light-tight and blackest. When the display device is an Organic Light Emitting Diode (OLED) display device, the drive voltage of the TFT of the white sub-pixel can be adjusted to change the drive current of the OLED, thereby reducing the amount of light emitted from the organic luminous layer and thus enabling the greyscale value of the white sub-pixel to reach the preset greyscale value. For example, when the OLED is turned off, the organic luminous layer does not emit light and the white sub-pixel has a greyscale value of 0 and is blackest.

Based on the above solution, adjusting the greyscale value of the sub-pixel corresponding to one of adjacent view points belonging respectively to adjacent ones of the plurality of view point regions to the preset greyscale value includes:

adjusting the greyscale voltage driving the white sub-pixel and adjusting the greyscale value of the white sub-pixel to the black greyscale value according to a preset correspondence between the greyscale voltage and the greyscale value of each sub-pixel.

There is a one-to-one correspondence between the greyscale voltage and the greyscale value of each sub-pixel. The display device can be debugged and the correspondence between the greyscale voltage and the greyscale value of each sub-pixel can be tested and set before the display device is delivered.

This solution adjusts the greyscale value of the white sub-pixel to 0, enabling the white sub-pixel region to become the blackest and thus eliminating impact of the white sub-pixel on a display image.

In addition, before adjusting the greyscale value of the sub-pixel corresponding to one of adjacent view points belonging respectively to adjacent ones of the plurality of view point regions to the preset greyscale value, the method further includes:

obtaining human eye position information of at least one user; and determining that the human eye position of any user falls into a reverse-scopic region according to the human eye position information.

Exemplarily, whether the human eyes fall into orthoscopic regions or the reverse-scopic region can be identified by a camera of the display device. When it is determined that the human eyes fall into the reverse-scopic region, the greyscale value of the sub-pixel corresponding to one of adjacent view points belonging respectively to adjacent ones of the plurality of view point regions is adjusted to the preset greyscale value. When it is determined that the eyes of all users fall into the orthoscopic regions, the greyscale value of each sub-pixel is normally adjusted, thus not affecting stereoscopic display in the orthoscopic regions.

According to the present disclosure, in the method for controlling naked eye stereoscopic display, during stereoscopic display on the display device, adjusting the greyscale value of the sub-pixel corresponding to one of adjacent view points belonging respectively to adjacent ones of the plurality of view point regions to the preset greyscale value enables the user to observe a plane image in the reverse-scopic region. The reverse-scopic phenomenon is eliminated and thus the visual fatigue is slowed and untoward effects such as dizziness are avoided.

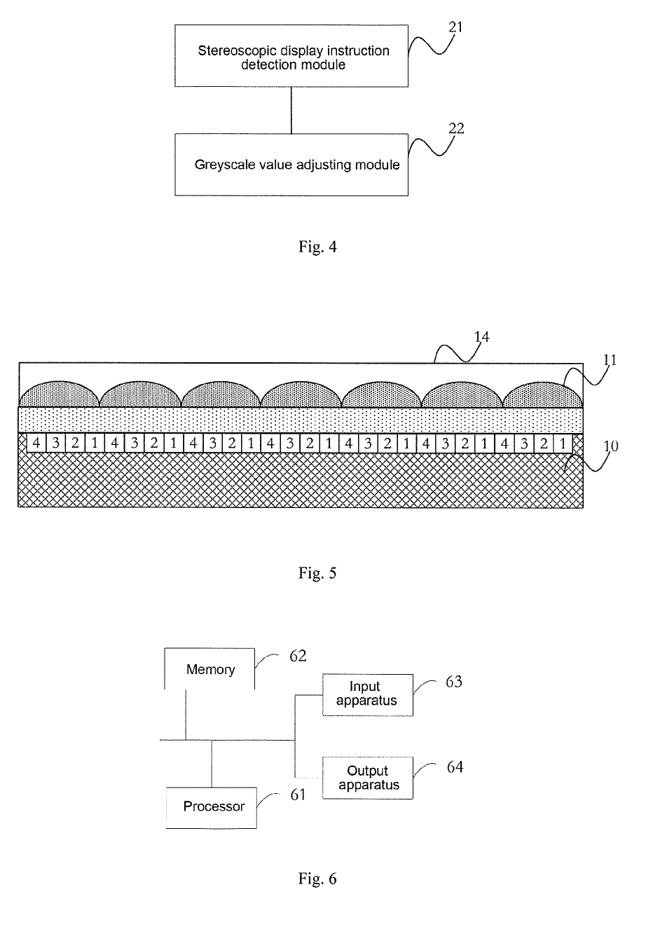

FIG. 4 is a block diagram of an apparatus for controlling naked eye stereoscopic display according to an embodiment of the present disclosure. As shown in FIG. 4, the apparatus includes at least one processor and a memory.

The memory stores computer-executable instructions executable by the at least one processor. The at least one processor performs operations in the following modules when executing the computer-executable instructions: a stereoscopic display instruction detection module 21 and a greyscale value adjusting module 22.

The stereoscopic display instruction detection module 21 is configured to detect a stereoscopic display instruction of a display device, where the display device is divided into a plurality of view point regions, each of which includes at least two view points.

The greyscale value adjusting module 22 is configured to adjust a greyscale value of a sub-pixel corresponding to one of adjacent view points belonging respectively to adjacent ones of the plurality of view point regions to a preset greyscale value when the stereoscopic display instruction of the display device is detected so that a user can observe a plane image in the reverse-scopic region.

In the above solution, each of the plurality of view point regions includes four view points corresponding to a white sub-pixel, a red sub-pixel, a green sub-pixel and a blue sub-pixel, respectively.

Optionally, sub-pixels corresponding to the adjacent view points belonging respectively to adjacent ones of the plurality of view point regions include the white sub-pixel.

Exemplarily, a greyscale value of each sub-pixel ranges from 0 to 255 and the preset greyscale value is not greater than 10.

Optionally, the greyscale value adjusting module 22 is configured to:

adjust a greyscale voltage driving the white sub-pixel and adjust a greyscale value of the white sub-pixel to the black greyscale value according to a preset correspondence between the greyscale voltage and the greyscale value of each sub-pixel so that the greyscale value of the white sub-pixel becomes 0.

Based on the above technical solution, the at least one processor further performs operations in the following modules: a human eye position information obtaining module and a human eye position determining module.

The human eye position information obtaining module is configured to obtain human eye position information of at least one user before the greyscale value of the sub-pixel corresponding to one of adjacent view points belonging respectively to adjacent ones of the plurality of view point regions is adjusted to the preset greyscale value.

The human eye position determining module is configured to determine that the human eye position of any user falls into the reverse-scopic region according to the human eye position information.

The apparatus for controlling naked eye stereoscopic display provided in the embodiment has functions and beneficial effects corresponding to the method for controlling naked eye stereoscopic display provided in embodiments of the present disclosure. For technical details not described in detail in the embodiment, see the method for controlling naked eye stereoscopic display provided in embodiments of the present disclosure.

FIG. 5 is a sectional diagram of a display device according to an embodiment of the present disclosure. As shown in FIG. 5, the display device includes a display panel 10 and a lens layer 14 disposed on a light outgoing side of the display panel 10.

The display panel 10 includes a plurality of sub-pixels disposed in a matrix form in a display region (not shown in the figure and see FIG. 1) and a control circuit disposed in a non-display region (not shown in the figure).

The control circuit includes the apparatus for controlling naked eye stereoscopic display in the above embodiments.

The lens layer 14 is used to project a display picture of each of the plurality of sub-pixels in different directions so that a user can observe a stereoscopic image in an orthoscopic region.

In the embodiment, the lens layer 14 includes a cylindrical lens array, a plurality of view point regions are disposed in a matrix form, and each cylindrical lens 11 covers one of the view point regions in each row. As shown in FIG. 5, each of the plurality of view point regions includes a first view point 1, a second view point 2, a third view point 3 and a fourth view point 4.

In the embodiment, the longitudinal direction of each cylindrical lens in the cylindrical lens array is perpendicular to the extending direction of each row of view point regions, that is, each cylindrical lens is disposed vertically. Alternatively, the included angle between this longitudinal direction and this extending direction of each row of view point regions is greater than or less than 90°, that is, each cylindrical lens is disposed obliquely. Optionally, the cylindrical lens array is disposed obliquely. Compared with vertical disposition, oblique disposition of each cylindrical lens can reduce the resolution of a display image in the column direction to increase the resolution of the display image in the row direction, thereby striking a balance between the resolution of the display image in the column direction and the resolution of the display image in the row direction.

The display device may be a cellphone, laptop, desktop, television or personal digital assistant.

The display device provided in the embodiment includes the apparatus for controlling naked eye stereoscopic display provided in embodiments of the present disclosure, and has corresponding functions and beneficial effects.

The present disclosure further provides a non-transient computer-readable storage medium storing computer-executable instructions configured to execute the method for controlling naked eye stereoscopic display in any one of the foregoing embodiments.

The present disclosure further provides a hardware structural diagram of a display device. As shown in FIG. 6, the display device includes:

one or more processors 61 and a memory 62. FIG. 6 uses one processor 61 as an example.

The device further includes an input apparatus 63 and an output apparatus 64.

The processor 61, memory 62, input apparatus 63 and output apparatus 64 may be connected by a bus or other means. FIG. 6 uses connection by a bus as an example.

As a non-transient computer-readable storage medium, the memory 62 is used for storing non-transient software programs, non-transient computer-executable programs and modules, such as program instructions or modules corresponding to the method for controlling naked eye stereoscopic display in embodiments of the present disclosure. The processor 61 is used for executing non-transient software programs, instructions and modules stored in the memory 62.

The memory 62 may include a program storage region and a data storage region. The program storage region may store an operating system and an application program required by at least one function while the data storage region may store data created based on use of an apparatus for controlling naked eye stereoscopic display. In addition, the memory 62 may include a high-speed random access memory and a non-transient memory, such as at least one disk memory, a flash memory or other non-transient solid-state memories.

The input apparatus 63 may receive inputted digital or character information and generate key signal input related to user settings and function control of the apparatus for controlling naked eye stereoscopic display. The output apparatus 64 may include a display screen and other display devices.

When executed by the one or more processors 61, the one or more modules, which are stored in the memory 62, execute the method in any one of the foregoing method embodiments.

The foregoing products may execute the method provided in the embodiments of the present disclosure and have the corresponding functional modules and beneficial effects of the method. For technical details not described in detail in the embodiment, see the method for controlling naked eye stereoscopic display provided in embodiments of the present disclosure.

The technical solution of the present disclosure may be embodied in the form of a software product that is stored in a storage medium and includes one or more instructions for enabling a computer device (which may be a personal computer, server, or network device, etc.) to perform all or part of the steps of the method provided in the embodiments of the present disclosure. The foregoing storage medium may be a non-transient storage medium, such as a U disk, mobile hard disk, read only memory (ROM), random access memory (RAM), magnetic disk, optical disk or other media that can store program codes, or a transient storage medium.

### INDUSTRIAL APPLICABILITY

The method and the apparatus for controlling naked eye stereoscopic display and the display device provided in the present disclosure can eliminate reverse-scopic phenomena and thus slow visual fatigue and avoid untoward effects such as dizziness.

What is claimed is:

1. A method for controlling naked eye stereoscopic display, comprising:
detecting a stereoscopic display instruction of a display device, wherein the display device has a plurality of view point regions, each of the plurality of view point regions includes at least two view points; and
adjusting a greyscale value of a sub-pixel corresponding to one of adjacent view points to a preset greyscale value when the stereoscopic display instruction of the display device is detected so that a user is allowed to observe a plane image in a reverse-scopic region, wherein the adjacent view points respectively belongs to adjacent ones of the plurality of view point regions.

2. The method of claim 1, wherein each of the plurality of view point regions includes four view points corresponding to a white sub-pixel, a red sub-pixel, a green sub-pixel and a blue sub-pixel, respectively; and
sub-pixels corresponding to the adjacent view points belonging respectively to adjacent ones of the plurality of view point regions include the white sub-pixel.

3. The method of claim 2, wherein the greyscale value of each sub-pixel ranges from 0 to 255 and the preset greyscale value is not greater than 10.

4. The method of claim 2, wherein the adjusting a greyscale value of a sub-pixel corresponding to one of adjacent view points belonging respectively to adjacent ones of the plurality of view point regions to a preset greyscale value includes:
adjusting a greyscale voltage driving the white sub-pixel and adjusting the greyscale of the white sub-pixel to a black greyscale according to a preset correspondence between a greyscale voltage and the greyscale value of each sub-pixel.

5. The method of claim 4, further comprising:
debugging the display device and testing and setting the correspondence between the greyscale voltage and the greyscale value of each sub-pixel before the display device is delivered.

6. The method of claim 4, further comprising:
adjusting a drive voltage of a thin film transistor of the white sub-pixel when the display device is an liquid crystal display device, so that the greyscale value of the white sub-pixel reaches the preset greyscale value.

7. The method of claim 4, further comprising:
adjusting a drive voltage of a thin film transistor of the white sub-pixel when the display device is an Organic Light-Emitting Diode (OLED) display device, so that the greyscale value of the white sub-pixel reaches the preset greyscale value.

8. The method of claim 1, wherein before the adjusting the greyscale value of the sub-pixel corresponding to one of adjacent view points belonging respectively to adjacent ones of the plurality of view point regions to the preset greyscale value, the method further comprises:
obtaining human eye position information; and
determining that a human eye position falls into the reverse-scopic region according to the human eye position information.

9. An apparatus for controlling naked eye stereoscopic display, comprising at least one processor and a memory, wherein
the memory stores computer-executable instructions executable by the at least one processor, the at least one processor performs operations in the following modules when executing the computer-executable instructions:
a stereoscopic display instruction detection module, configured to detect a stereoscopic display instruction of a display device, wherein the display device is divided into a plurality of view point regions, each of the plurality of view point regions includes at least two view points; and
a greyscale value adjusting module, configured to adjust a greyscale value of a sub-pixel corresponding to one of adjacent view points to a preset greyscale value when the stereoscopic display instruction of the display device is detected so that a user can observe a plane image in a reverse-scopic region, wherein the adjacent view points respectively belongs to adjacent ones of the plurality of view point regions.

10. The apparatus of claim 9, wherein each of the plurality of view point regions includes four view points corresponding to a white sub-pixel, a red sub-pixel, a green sub-pixel and a blue sub-pixel, respectively; and
sub-pixels corresponding to the adjacent view points belonging respectively to adjacent ones of the plurality of view point regions include the white sub-pixel.

11. The apparatus of claim 10, wherein a greyscale value of each sub-pixel ranges from 0 to 255 and the preset greyscale value is not greater than 10.

12. The apparatus of claim 11, wherein the greyscale value adjusting module is configured to:
adjust a greyscale voltage driving the white sub-pixel and adjust the greyscale of the white sub-pixel to a black greyscale according to a preset correspondence between the greyscale voltage and the greyscale value of each sub-pixel.

13. The apparatus of claim 12, wherein the at least one processor further performs operations in the following module:
a test module, configured to debug the display device and test and set a correspondence between the greyscale voltage and the greyscale value of each sub-pixel before the display device is delivered.

14. The apparatus of claim 12, wherein the at least one processor further performs operations in the following module:
a first adjusting module, configured to adjust a drive voltage of a thin film transistor of the white sub-pixel when the display device is a liquid crystal display device, so that the greyscale value of the white sub-pixel reaches the preset greyscale value.

15. The apparatus of claim 12, wherein the at least one processor further performs operations in the following module:
a second adjusting module, configured to adjust a drive voltage of a thin film transistor of the white sub-pixel when the display device is an Organic Light-Emitting Diode device, so that the greyscale value of the white sub-pixel reaches the preset greyscale value.

16. The apparatus of claim 9, wherein the at least one processor further performs operations in the following modules:
a human eye position information obtaining module, configured to obtain human eye position information before the greyscale value of the sub-pixel corresponding to one of adjacent view points belonging respectively to adjacent ones of the plurality of view point regions is adjusted to the preset greyscale value; and
a human eye position determining module, configured to determine that the human eye position falls into the reverse-scopic region according to the human eye position information.

17. A display device, comprising a display panel and a lens layer disposed on a light outgoing side of the display panel, wherein
the display panel includes a plurality of sub-pixels disposed in a matrix form in a display region and a control circuit disposed in a non-display region;
the control circuit includes an apparatus for controlling naked eye stereoscopic display;
the lens layer is used to project a display picture of each of the plurality of sub-pixels in different directions so that a user can observe a stereoscopic image in an orthoscopic region; and
the apparatus for controlling naked eye stereoscopic display includes at least one processor and a memory, where
the memory stores computer-executable instructions executable by the at least one processor, the at least one processor performs operations in the following modules when executing the computer-executable instructions:
a stereoscopic display instruction detection module, configured to detect a stereoscopic display instruction of a display device, where the display device is divided into a plurality of view point regions, each of the plurality of view point regions includes at least two view points; and
a greyscale value adjusting module, configured to adjust a greyscale value of a sub-pixel corresponding to one of adjacent view points to a preset greyscale value when the stereoscopic display instruction of the display device is detected so that a user can observe a plane image in a reverse-scopic region, wherein the adjacent view points respectively belongs to adjacent ones of the plurality of view point regions.

18. The display device of claim 17, wherein the lens layer includes a cylindrical lens array, the plurality of view point regions are disposed in a matrix form, and each cylindrical lens covers one of the view point regions in each row; and
the cylindrical lens array is disposed obliquely.

19. (canceled)
